(19) United States
(12) Patent Application Publication
(10) Pub. No.: US 2025/0168290 A1
(43) Pub. Date: May 22, 2025

(54) IMAGE FORMING APPARATUS

(71) Applicant: CANON KABUSHIKI KAISHA, Tokyo (JP)

(72) Inventor: TAICHI TAKEMURA, Chiba (JP)

(21) Appl. No.: 18/950,657

(22) Filed: Nov. 18, 2024

(30) Foreign Application Priority Data
Nov. 21, 2023 (JP) 2023-197594
Sep. 11, 2024 (JP) 2024-157739

(51) Int. Cl. H04N 1/405

(52) U.S. Cl. CPC H04N 1/405

(57) ABSTRACT

An image forming apparatus has an image processing unit that performs halftoning on image data and is controlled based on image forming conditions. The image forming unit forms an image based on image data on a sheet. A detection unit detects a detection image on the image carrier. A generation unit generates image forming conditions based on a detection result of the detection image. The image processing unit performs halftoning on the image data with a screen corresponding to attribute information of the image data, the screen including a first screen with a first number of screen lines and a second screen with a second number of screen lines greater than the first number of screen lines. The number of screen lines used for the detection image is greater than the number of lines of the first screen.

### BACKGROUND

### Field of the Disclosure

The present disclosure relates to an image forming apparatus and particularly relates to calibration technology therefor.

### Description of the Related Art

Typically, with a known image forming apparatus using an electrophotographic image forming process, the image density varies due to the operating environment and the degradation of components inside the image forming apparatus. Regarding this, recent image forming apparatus perform image density control (image forming condition control) that adjusts image forming conditions such as exposure amount, developing bias, γ correction table, and the like to obtain an image with stable density. In the image density control, a detection image (a pattern image) is formed on an image carrier such as an intermediate transfer body, for example, the toner amount of the pattern image is detected by an optical sensor, and the image forming conditions such as exposure amount, developing bias, γ correction table, and the like are adjusted on the basis of the detection result.

However, in the image forming apparatus, the resolution is increased to 600 dpi, 1200 dpi, or the like and the image density is varied across the area using a plurality of pixels to artificially display a halftone image. The image processing performed in the process of converting the input image data into halftone image data is halftone processing.

The input image data can be categorized into the following three types of images:
(1) Text and line image,
(2) Photo image, and
(3) Graphic image.

Of the three types of input image data, the (1) text and line image has the characteristic of emphasizing the reproducibility of the shape of text and lines but having reduced emphasis on the color reproducibility and tone reproducibility. Alternatively, the (2) photo image and the (3) graphic image have the opposite feature of emphasizing color reproducibility and tone reproducibility over shape reproducibility. A known method for switching the number of screen lines of a halftone processing (JP H9-282471) includes performing screen processing with a high number of screen lines for text and line images, outlines, and the like and performing screen processing with a low number of screen lines for photo images and the like.

As image density control for forming an image with a target maximum density, a calibration method using a detection image is known. With this method, for example, a plurality of images for detection are formed on a basis of a plurality of different image forming conditions on an intermediate transfer body, a plurality of images for detection are detected by a detection unit, and an image forming condition for forming an image with the target density is determined on the basis of the detection result of each detection image detected by the detection unit.

In the image density control, color reproducibility and tone reproducibility is emphasized over reproducibility of the shape of text and lines. Thus, there may be a case where a screen with the low number of screen lines suitable for color reproducibility and tone reproducibility is applied to a detection image formed for controlling the image density.

However, in the case of using a detection image after screen processing with the low number of screen lines has been performed for controlling the image forming condition, there may be a large variation in the detection values of a sensor for detecting a detection image, meaning that the image density cannot be controlled to a high accuracy.

### SUMMARY

The present disclosure has been made in consideration of the aforementioned problems and realizes generating an image forming condition for forming an image with a target maximum density with high accuracy.

One aspect of the present disclosure provides an image forming apparatus that forms an image on a sheet, comprising: an image processor configured to perform halftone processing corresponding to an attribute of an image to be formed based on image data, the image processor outputting halftoned image data; an image forming unit configured to be controlled on a basis of an image forming condition and form an image on a basis of the halftoned image data outputted by the image processor; an image carrier on which a detection image is formed by the image forming unit; a sensor configured to receive reflected light from the detection image; and a processor configured to: control the image forming unit to form a detection image for tone correction, the detection image for tone correction being subjected to halftone processing, control a tone characteristic of an image of a first attribute to be formed by the image forming unit on a basis of a light-receiving result of light reflected from a first detection image by the sensor, the first detection image being subjected to halftone processing corresponding to the first attribute, control a tone characteristic of an image of a second attribute different from the first attribute to be formed by the image forming unit on a basis of a light-receiving result of light reflected from a second detection image by the sensor, the second detection image being subjected to halftone processing corresponding to the second attribute, control the image forming unit to form a detection image for target maximum density correction, the detection image for target maximum density correction being subjected to error diffusion processing as the halftone processing regardless of an attribute of the image to be formed, and generate the image forming condition for correcting a target maximum density of the image to be formed by the image forming unit on a basis of a light-receiving result of light reflected from the detection image for the target maximum density correction by the sensor.

Another aspect of the present disclosure provided an image forming apparatus that forms an image on a sheet, comprising: an image processor configured to perform halftone processing corresponding to an attribute of an image to be formed based on image data, the image processor outputting halftoned image data; an image forming unit configured to be controlled on a basis of an image forming condition and form an image on a basis of the halftoned image data outputted by the image processor; an image carrier on which a detection image is formed by the image forming unit; a sensor configured to receive reflected light from the detection image; and a processor configured to: control the image forming unit to form a detection image for tone correction, the detection image for tone correction being subjected to halftone processing, control a tone characteristic of an image of a first attribute to be formed by the image forming unit on a basis of a light-receiving result of light reflected from a first detection image by the sensor, the first detection image being subjected to halftone processing corresponding to the first attribute, control a tone characteristic of an image of a second attribute different from the first attribute to be formed by the image forming unit on a basis of a light-receiving result of light reflected from a second detection image the sensor, the second detection image being subjected to halftone processing corresponding to the first attribute, control the image forming unit to form a detection image for target maximum density correction, and generate the image forming condition for correcting a target maximum density of the image to be formed by the image forming unit on a basis of a light-receiving result of light reflected from the detection image for the target maximum density correction by the sensor, wherein the detection image for the target maximum density correction is an image subjected to halftone processing using a number of second screen lines greater than a number of first screen lines used in halftone processing corresponding to the first attribute.

According to the present disclosure, an image forming condition for forming an image with a target maximum density can be generated with high accuracy.

Further features of the present disclosure will become apparent from the following description of exemplary embodiments with reference to the attached drawings.

### BRIEF DESCRIPTION OF THE DRAWINGS

FIG. 1 is a schematic view of an image forming apparatus according to a present embodiment.

FIG. 2 is a schematic view of a main portion illustrating the configuration of an image forming unit in the image forming apparatus of FIG. 1.

FIG. 3 is a schematic view of the configuration of a scanner unit in the image forming apparatus of FIG. 1.

FIG. 4 is a functional block diagram of the image forming apparatus of FIG. 1.

FIG. 5 is a schematic view of the configuration of a patch detection sensor in the image forming apparatus of FIG. 1.

FIG. 6 is a schematic view of a pattern image for correction when performing maximum density correction control.

FIG. 7 is a diagram illustrating the relationship between the density at an image print ratio of 80% and the density at a print ratio of 100%.

FIG. 8 is a flowchart of maximum density correction control.

FIG. 9 is a diagram illustrating an example of a conversion table for converting charging bias and exposure amount to development contrast.

FIG. 10 is a diagram illustrating the relationship between the density of a pattern image for correction and development contrast.

FIG. 11 is a diagram illustrating the relationship between the sensor detection density of a patch when subjected to SCR processing with the high number of screen lines and the actual measurement density in a first embodiment.

FIG. 12 is a diagram illustrating the relationship between the sensor detection density of a patch when subjected to SCR processing with the low number of screen lines and the actual measurement density in a first embodiment.

FIG. 13 is a diagram illustrating the relationship between the sensor detection density of a patch when subjected to error diffusion processing and the actual measurement density in a second embodiment.

FIG. 14 is a diagram illustrating an example of a digital image subjected to SCR processing with the high number of screen lines in the first embodiment.

FIG. 15 is a diagram illustrating an example of a digital image subjected to SCR processing with the low number of screen lines in the first embodiment.

FIG. 16 is a diagram illustrating an example of a digital image subjected to error diffusion processing in the second embodiment.

FIG. 17 is a diagram illustrating an example of potential distribution simulation results with respect to an image subjected to SCR processing with the high number of screen lines in the first embodiment.

FIG. 18 is a diagram illustrating an example of potential distribution simulation results with respect to an image subjected to SCR processing with the low number of screen lines in the first embodiment.

FIG. 19 is a diagram illustrating an example of potential distribution simulation results with respect to an image subjected to error diffusion processing in the second embodiment.

FIG. 20 is a diagram illustrating potential distribution variation results in a potential distribution simulation of halftone processing in an embodiment.

FIG. 21 is a schematic view of a pattern image for correction used in tone correction control.

FIG. 22 is a schematic cross-sectional view illustrating an image forming apparatus according to another embodiment.

FIGS. 23A and 23B are schematic views of a main portion illustrating an exposure head provided in an image forming apparatus according to another embodiment.

FIGS. 24A to 24C are schematic views illustrating the configuration of an exposure head provided in an image forming apparatus according to another embodiment.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

### Image Forming Apparatus

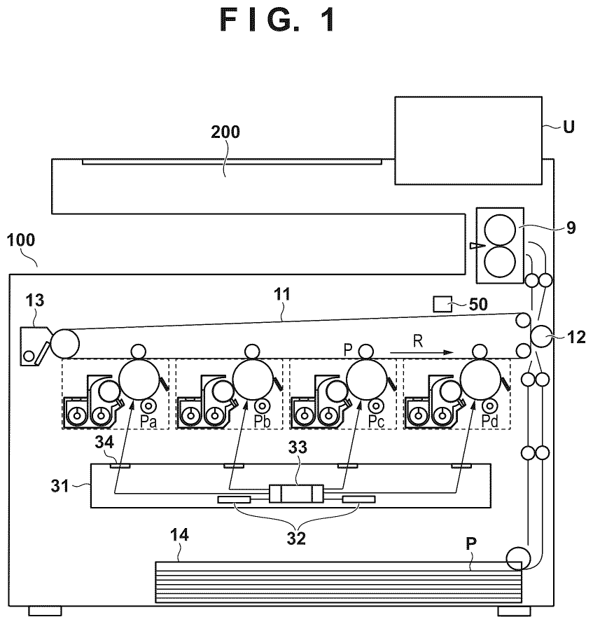

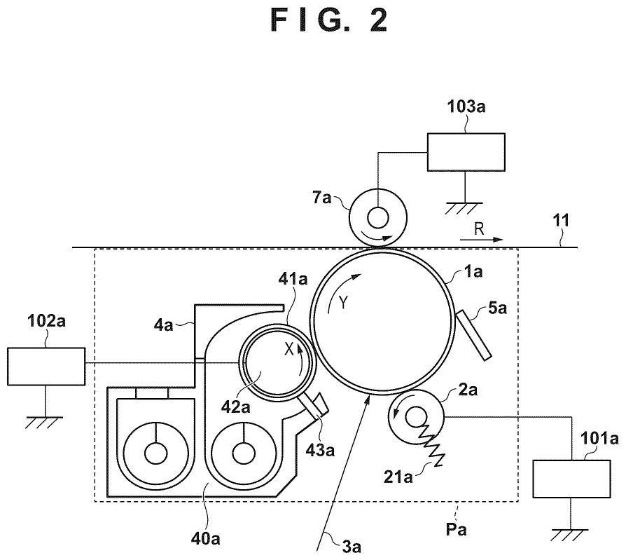

FIGS. 1 and 2 are cross-sectional views illustrating an example of a color image forming apparatus 100 of an intermediate transfer system according to the present disclosure. The image forming apparatus 100 is an electro-photographic laser beam multi-function peripheral that uses a contact charging system and a two-component contact development system.

As illustrated in FIG. 1, the image forming apparatus 100 includes four image forming stations Pa, Pb, Pc, and Pd as image forming units arranged side by side in a rotation direction (arrow R) of an intermediate transfer belt 11. FIG. 2 is a schematic cross-sectional view of the image forming station Pa. The four image forming stations Pa, Pb, Pc, and Pd have a similar configuration. As illustrated in FIG. 2, the image forming station Pa includes a photosensitive drum 1a correspond to a photosensitive member, a charging roller 2a, a developing device 4a, a cleaning apparatus 5a, and a primary transfer apparatus 7a. Note that in the diagram, an arrow 3a indicates a laser beam emitted from a laser scanner 31 (FIG. 1) to the photosensitive drum 1a. Also, the intermediate transfer belt 11 corresponding to an intermediate transfer body is disposed moveable in the direction of the arrow R so as to pass between the photosensitive drums 1a, 1b, 1c, and 1d of the image forming stations Pa, Pb, Pc, and Pd and the primary transfer apparatuses 7a, 7b, 7c, and 7d.

As illustrated in FIG. 1, the laser scanner 31 includes a light source 32, a polygon mirror 33, and a transmission window 34 is installed at the lower portion of the image forming apparatus 100. A laser beam emitted from the light source 32 is rotated by the polygon mirror 33 and becomes a scanning beam. The light beam of the scanning beam is deflected by a plurality of reflection mirrors and gathered on a generating line of the charged photosensitive drums 1a, 1b, 1c, and 1d by an fθ lens for exposure. In this manner, an electrostatic latent image in accordance with the image signal is formed on the photosensitive drum.

The developing devices 4a, 4b, 4c, and 4d of the four image forming stations Pa, Pb, Pc, and Pd are each filled with a two-component developer containing a non-magnetic toner, respectively yellow, magenta, cyan, and black, and a magnetic carrier mixed at a predetermined mixing ratio. The developing devices 4a, 4b, 4c, and 4d form a toner image by developing the electrostatic latent image on the photosensitive drum using the toner of each color. The toner image of each color is primary-transferred on the intermediate transfer belt 11 from the photosensitive drums 1a, 1b, 1c, and 1d. A sheet housed in a cassette 14 is conveyed to a secondary transfer roller 12, the toner image carried on the intermediate transfer belt 11 is secondary-transferred to the sheet, and after the toner image is fixed at a fixing device 9 by heat and pressure, the sheet is discharged outside of the apparatus as a printed image.

A cleaning blade 13 that cleans the toner (remaining toner) adhered to the surface of the intermediate transfer belt 11 is provided downstream of the secondary transfer position in the rotation direction (arrow R) of the intermediate transfer belt 11. Also, the toner (remaining toner) remaining on the photosensitive drum 1a is removed by the cleaning apparatus 5a from above the photosensitive drum 1a. The same applies for the other image forming stations. Also, the image forming apparatus 100 includes a patch detection sensor 50, which is an optical sensor that detects the light reflected from the toner pattern on the intermediate transfer belt 11.

Also, a reader 200 that reads documents and a control panel U that receives operations from a user are provided at an upper portion of the image forming apparatus 100. The control panel U includes a liquid crystal touch panel, for example.

Here, the image forming apparatus 100 performs image formation at a process speed of 200 mm/sec. Process speed is the rotational speed of the photosensitive drums 1a, 1b, 1c, and 1d. The process speed may also be referred to as the rotational speed of the intermediate transfer belt 11. Also, the process speed may be referred to as the conveyance speed of the sheet passing through the secondary transfer position.

The image forming apparatus 100 uniformly charges the surface of the photosensitive drum 1a by applying a high voltage to the charging roller 2a. The charging roller 2a is held in a freely rotatable manner by a bearing member (not illustrated) at both end portions of the core metal and is biased toward the photosensitive drum 1a by a pressing spring 21a to press it against the surface of the photosensitive drum 1a with a predetermined pressing force. In this manner, the charging roller 2a is driven in rotation by the rotation of the photosensitive drum 1a. A charging bias voltage of a predetermined condition is applied to the core metal of the charging roller 2a by a high-voltage power source 101a. Accordingly, the surface of the rotating photosensitive drum 1a is subjected to contact charging processing to a predetermined polarity and potential. In the present embodiment, the charging bias voltage applied to the charging roller 2a is an oscillation voltage obtained by superimposing a DC voltage and an AC voltage. Specifically, the oscillation voltage is obtained by superimposing a DC voltage and a sine wave AC voltage with a frequency of 1.3 kHz and a peak-to-peak voltage Vpp of 1.5 kV. When a DC voltage of −600 V is applied as the charging bias voltage, the surface of the photosensitive drum 1a is uniformly charged to −600 V (dark potential Vd), which is the same as the DC voltage applied to the charging roller 2a. Note that the charging member that charges the photosensitive drum 1a is not limited to the configuration of the charging roller 2a. The charging member may be a corona charging device that charges the photosensitive drum 1a by a wire to which a charging bias voltage is applied, for example.

Next, the image forming apparatus 100 performs exposure of the surface of the charged photosensitive drum 1a via a laser beam 3a from the laser scanner 31 in order to form the electrostatic latent image on the photosensitive drum 1a. The laser scanner 31 is a laser beam scanner using a semiconductor laser as the light source 32.

Next, the image forming apparatus 100 develops the electrostatic latent image on the photosensitive drum 1a using toner via the developing device 4a. In this manner, a toner image (developer image) is formed on the photosensitive drum 1a. The developing device 4a is a developing device that uses a two-component contact development system that performs development while bringing a magnetic brush of a two-component developer containing a non-magnetic toner and a magnetic carrier housed in a development container 40a into contact with the photosensitive drum. Also, in the present embodiment, a non-magnetic toner of negative polarity is used. The developing device 4a includes a non-magnetic developing sleeve 41a as a developer carrier. Inside the developing sleeve 41a, a magnet for generating a magnetic field is disposed. The developing sleeve 41a is exposed to the outside of the developing device 4a at a portion of the outer circumferential surface and is disposed opposing the photosensitive drum 1a in close proximity with the closest distance (S-D gap) being 260 μm. The portion where the photosensitive drum 1a and the developing sleeve 41a oppose one another corresponds to a developing region. Also, the developing sleeve 41a is rotationally driven in a rotation direction X which is the same direction as a rotation direction Y of the photosensitive drum 1a in the developing region. The rotating developing sleeve 41a carries and conveys the two-component developer thinly layered on the developing sleeve 41a via a regulating member 43a. A predetermined developing bias is applied to the developing sleeve 41a from a high-voltage power source 102a. In the present embodiment, the developing bias voltage is an oscillation voltage obtained by superimposing a DC voltage and an AC voltage. Specifically, the oscillation voltage is obtained by superimposing a DC voltage of −450 V and a rectangular wave AC voltage with a frequency of 8.0 kHz and a peak-to-peak voltage Vpp of 1.8 kV. With the electrical field of the electrostatic latent image formed on the surface of the photosensitive drum 1a and the developing bias, an electrostatic latent image is developed in reverse.

Next, the image forming apparatus 100 primary-transfers the developer image formed on the photosensitive drum 1a to the intermediate transfer belt 11 via the primary transfer apparatus 7a. In the present embodiment, the primary transfer apparatus 7a is a transfer roller. The transfer roller 7a pressing against the photosensitive drum 1a with a predetermined pressing force. A transfer bias, of +1 kV in the present embodiment, of a positive polarity, which is the opposite polarity to the negative polarity of the toner charging polarity, is applied to the transfer roller 7a from a high-voltage power source 103a, and the toner is primary-transferred to the intermediate transfer belt 11.

As described above, while the photosensitive drum 1a is rotating, charging processing to uniformly charge the photosensitive drum 1a to a predetermined potential (the dark area potential Vd) and a predetermined polarity via the charging roller 2a is performed, and the photosensitive drum 1a is subjected to exposure in accordance with an image signal via the laser scanner 31 (laser beam 3a). Accordingly, an electrostatic latent image (light area potential VL) corresponding to the color component image of the target color image is formed. The electrostatic latent image is developed by a developing roller 42a at the developing position and visualized as a toner image. Here, a voltage (charging bias voltage) is applied to the charging roller 2a to make it the dark area potential Vd, and the exposure amount from the laser scanner 31 (laser beam 3a) is determined to make it the light area potential VL. Also, a developing bias voltage Vdc is applied to the developing roller 42a. Here, the absolute value of the difference between the light area potential VL and the developing bias voltage Vdc is referred to as the development contrast.

### Reader

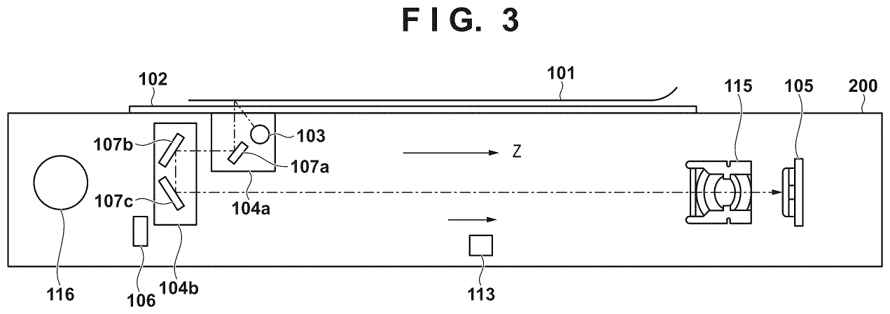

FIG. 3 is a schematic view illustrating the configuration of the reader 200. The reader 200 includes, inside its casing, a first mirror unit 104a, a second mirror unit 104b, an image sensor 105, a lens 115, a motor 116, a document size detection sensor 113, and a home position sensor 106. The first mirror unit 104a includes a document illumination lamp 103 and a first mirror 107a. The second mirror unit 104b includes a second mirror 107b and a third mirror 107c. The first mirror unit 104a and the second mirror unit 104b are driven by the motor 116 and can move in the Z direction.

When a document is read, the motor 116 rotates to move the first mirror unit 104a and the second mirror unit 104b temporarily to the home position where the home position sensor 106 is. On a document platen glass 102, a single document is fixed with its reading surface orientated toward the document platen glass 102 by a pressure plate or an ADF unit (not illustrated). The reader 200 turns on the document illumination lamp 103 and illuminates the reading surface of a document 101. The first mirror unit 104a and the second mirror unit 104b move in the Z direction to deflect the image light from the document 101 via the first mirror 107a, the second mirror 107b, and the third mirror 107c and guide the image light to the lens 115. The lens 115 focuses the image light on the light-receiving surface of the image sensor 105. The image sensor 105 converts the image light into an electrical signal.

### Block Diagram

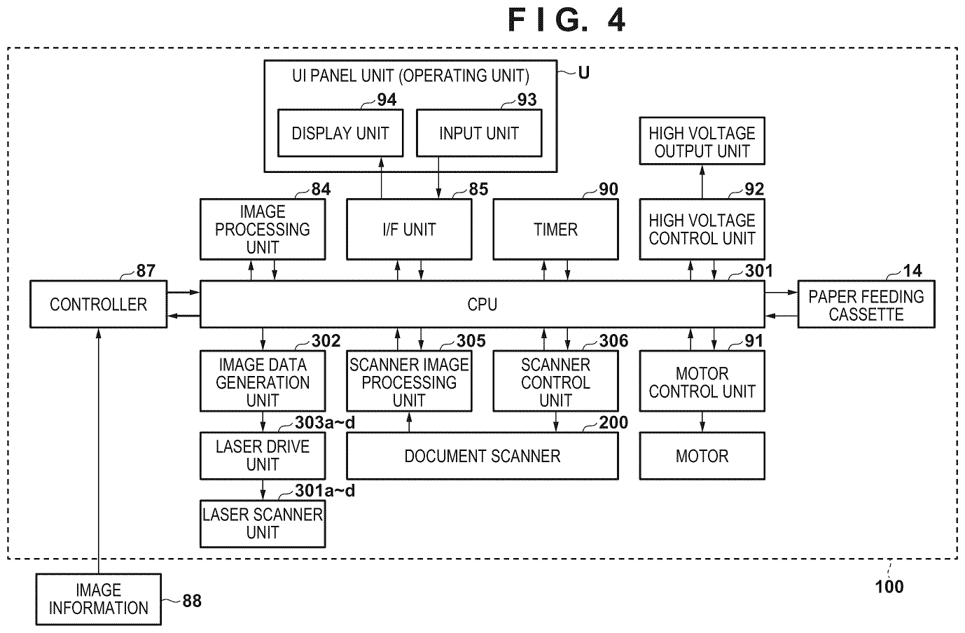

FIG. 4 is a schematic functional block diagram of the image forming apparatus 100. A CPU 301 includes a function of generating various types of command signals and executing computational processing for operating various types of sensors, motors, and the like of the image forming apparatus 100 in accordance with the electrophotographic process. Also, an inbuilt memory for storing data is provided inside the CPU 301. An image data generation unit 302 includes a function of converting various types of image data into signals for laser control and sending control signals to laser drive units 303a to 303d. The image data generation unit 302 also has a function of generating toner patterns for various types of adjustments.

The laser drive units 303a to 303d include a function of driving laser elements of laser scanners 301a to 301d on the basis of signals sent from the image data generation unit 302 and controlling the turning on and light amount of the lasers. A scanner control unit 306 includes a function of controlling the on/off of the illumination lamp 103 inside the reader 200 and the driving of the motor 116 in accordance with command signals from the CPU 301. A scanner image processing unit 305 obtains electrical signals from the image sensor 105 inside the reader 200, generates image signals, and sends the image signals to the CPU 301.

A motor control unit 91 is electrically connected to various drive motors (not illustrated) and includes a function of controlling the drive timing and the drive speed. A high voltage control unit 92 includes a function of controlling the output of bias required in the image forming process, such biases including a charging bias, a developing bias, and a transfer bias.

Also, the CPU 301 is electrically connected to the cassette 14, and I/F unit 85, and a timer 90 and is further connected to the control panel U via the I/F unit 85. The CPU 301 can perform image formation using a printing material P stored inside the cassette 14. Also, the control panel U receives operations by the user and is constituted by a liquid crystal touch panel or the like functioning as an input unit 93 and a display unit 94. Note that the control panel U may be a personal computer or similar external terminal connected to the image forming apparatus.

Also, the CPU 301 is electrically connected to a controller 87 and an image processing unit 84. Image information 88 is sent to the CPU 301 via the controller 87. The CPU 301 can form images by processing being performed on the received image information 88 at the image processing unit 84.

The image processing unit 84 performs halftone processing on the image information 88 (input image data). The image information 88 (input image data) includes information (attribute information) relating to the image type for each region of the image. The image type (attribute information) is one of the following three types.
(1) Text and line image
(2) Photo image
(3) Graphic image

Here, for (1) text and line image, the reproducibility of the shape of text and lines is emphasized, and for (2) photo image and (3) graphic image, color reproducibility and tone reproducibility are emphasized.

The image processing unit 84 performs screen processing using a screen with the high number of screen lines on the input image data of the image information 88 provided with attribute information categorized into text, line image, and the like. The screen with the high number of screen lines is a screen of 230 lines/inch, for example. The image processing unit 84 generates an image (image data) represented using the 230 line/inch screen from the input image data of the image information 88 provided with attribute information categorized into text, line image, and the like.

Also, the image processing unit 84 performs screen processing using a screen with the low number of screen lines on the input image data of the image information 88 provided with attribute information categorized into photo image and graphic image. The screen with the low number of screen lines is a screen of 170 lines/inch, for example. The image processing unit 84 generates an image (image data) represented using the 170 line/inch screen from the input image data of the image information 88 provided with attribute information categorized into photo image and graphic image. The number of screen lines used for reproducing a photo image and a graphic image emphasizing color reproducibility and tone reproducibility is less than the number of screen lines used for reproducing text and a line image emphasizing shape reproducibility. Note that the number of screen lines used for reproducing a photo image and a graphic image is preferably 190 lines/inch or less. The number of screen lines used for reproducing text and a line image is preferably 190 lines/inch or greater.

### Patch Detection Sensor

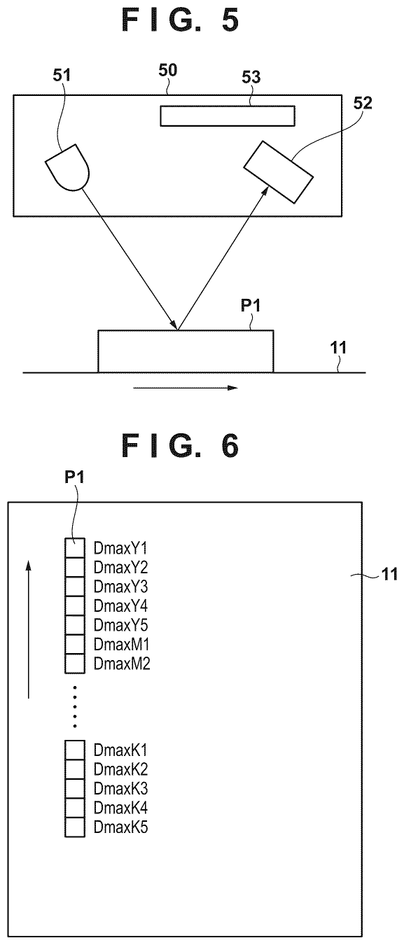

FIG. 5 is a schematic view illustrating the configuration of the patch detection sensor 50. The patch detection sensor 50 is a sensor that measures the light reflected from a measurement target. The patch detection sensor 50 described in the present embodiment is a specular reflection type including a light-emitting unit 51 as an irradiation unit and a light-receiving unit 52 as an output unit. The light-emitting unit 51 is an LED, for example, and the light-receiving unit 52 is a photodiode, for example. The patch detection sensor 50 further includes an IC 53 that controls the emitted light amount (irradiation light amount) of the light-emitting unit 51 as one of the irradiation conditions. The light-emitting unit 51 is installed in a manner so that light is emitted at an angle of 45 degrees with respect to a normal line of the intermediate transfer belt 11 and emits light at the intermediate transfer belt 11. The light-receiving unit 52 is installed at a symmetrical position to the light-emitting unit 51 with respect to the normal line of the intermediate transfer belt 11 and receives specular reflection light from the underlayer of the intermediate transfer belt 11 or the toner image corresponding to the illumination region and outputs a value in accordance with the received-light result (reflected light level). FIG. 5 illustrates an example in which one patch of a toner pattern image P1 passes the measurement region of the patch detection sensor 50. The CPU 301 converts a measurement result (output value of the light-receiving unit 52) of the reflected light from the toner pattern image P1 measured by the patch detection sensor 50 into a density value. Here, a table (patch detection brightness and density conversion table) for converting the output values of the patch detection sensor 50 corresponding to the toner pattern image P1 into density values is pre-stored in the image processing unit 84 and generated together with the output characteristics of the patch detection sensor 50.

Note that in the present embodiment described herein, the patch detection sensor 50 is a specular reflection type, but a diffuse reflection type patch detection sensor may be used. With the specular reflection type, yellow, magenta, cyan, and black toner can be detected, but up to an image print ratio of the toner pattern image P1 of 100%, highly accurate detection cannot be performed. With the diffuse reflection type, yellow, magenta, and cyan toner can be detected even up to an image print ratio of the toner pattern image P1 of 100%, but the black toner cannot be detected.

Here, the image print ratio for a certain region may specifically be a value (or the value displayed as a percentage) obtained by dividing a value of the accumulated density data of each pixel included in the region by the accumulated value of a case where all of the pixel values of the region is the maximum density. For example, the image print ratio of a fully filled-in region at the maximum density (density of 100%) of one pixel is 100%, and the image print ratio of a region without an image formed is 0%.

### Maximum Density Control via Patch Detection

Typically, density correction control is categorized into two types: maximum density correction control in which development contrast is adjusted by changing the exposure amount, the charging bias voltage, the developing bias voltage, or the like and tone correction control in which a LUT (γ correction table) corresponding to the type of halftone processing is generated. The exposure amount, the charging bias voltage, and the developing bias voltage are examples of image forming conditions for correcting the target maximum density of an image to be formed by the image forming stations Pa, Pb, Pc, and Pd. The LUT (γ correction table) is an example of a tone correction condition for correcting the tone characteristics of an image to be formed by the image forming stations Pa, Pb, Pc, and Pd.

FIG. 6 is a diagram illustrating an example of the toner pattern image P1 for development contrast correction used in maximum density adjustment control via patch detection. The toner pattern image P1 functions as a detection image for target maximum density correction. In the present embodiment, the toner pattern image P1 is formed on the intermediate transfer belt 11. Note that it is sufficient that the toner pattern image P1 is formed on an image carrier, and the toner pattern image P1 may be formed on the photosensitive drum 1a. The patch detection sensor 50 may be disposed opposite the image carrier where the toner pattern image P1 is formed.

FIG. 6 is a representative of the rotation direction of the intermediate transfer belt 11. The toner pattern image P1 is 25 mm×25 mm in the present example. The toner pattern image P1 is formed for each toner color component, Y, M, C, K, while changing the exposure amount, the charging bias voltage, the developing bias voltage, and the like and with the development contrast changed using five steps of Vc1, Vc2, Vc3, Vc4, and Vc5 (five patches of each color). A total of 20 toner pattern images P1 are formed in the rotation direction (circumferential direction) of the intermediate transfer belt 11. Note that if the image print ratio is too high, the detection accuracy of the specular reflection type patch detection sensor 50 is reduced. Thus, in the present embodiment, the image print ratio of the toner pattern image P1 is set to 80%. The density relationship between when the image print ratio is 80% and 100% is obtained in advance.

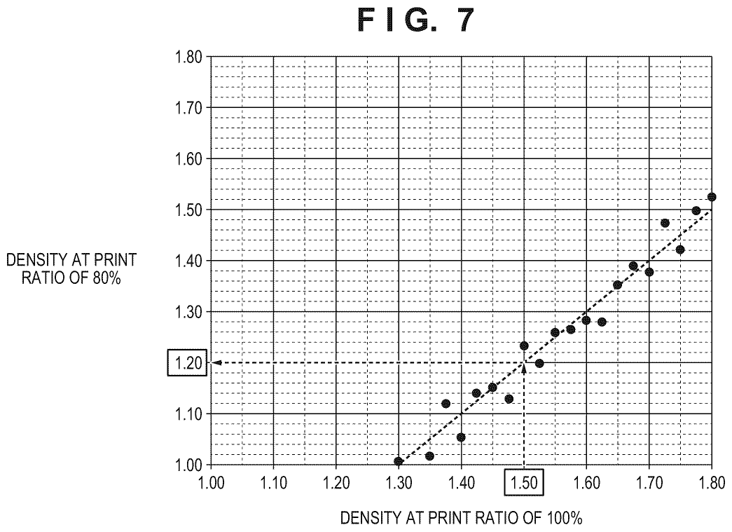

FIG. 7 illustrates the relationship between the density at an image print ratio of 80% and the density at an image print ratio of 100%. In a case where a target maximum density Dmax_Target at an image print ratio of 100% is 1.50, the development contrast is determined so that a density signal value D_80% obtained from a toner pattern image for correction formed at an image print ratio of 80% is equal to 1.20.

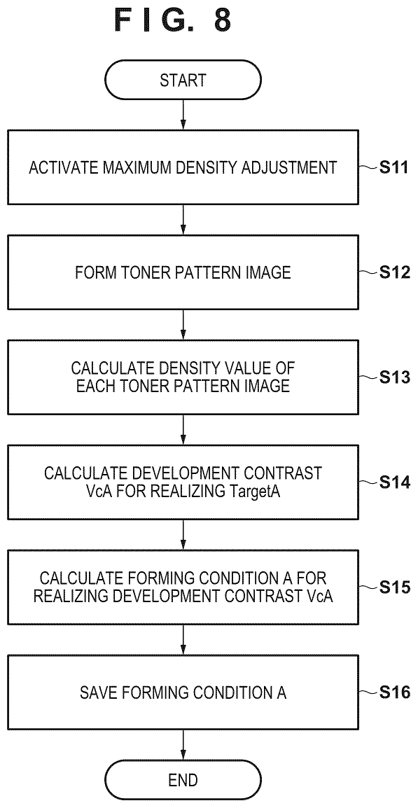

FIG. 8 is a flowchart of the processing for maximum density control via patch detection. The processing of the flowchart is implemented by the CPU 301 loading a program stored in the ROM of the image processing unit 84 to the RAM or similar memory of the CPU 301 and executing the program.

In step S11, the CPU 301 determines to activate maximum density control via patch detection. The activation condition is either when a user or service person issues an instruction to perform maximum density control via patch detection from the control panel U or when the CPU 301 determines that, when the cumulative number of image formation operations is a predetermined number or greater, the maximum density control needs to be performed.

In step S12, the CPU 301 forms the toner pattern image P1 using the maximum density control via patch detection. Here, the toner pattern image P1 of the present example includes five patches with an image print ratio of 80 percent for each toner color component as illustrated in FIG. 6. The five patches may all be the same image data. For example, in a case where the maximum density is 1 and the minimum density is 0, halftone image data of five patches uniformly filled with pixels of a density of 0.8 is prepared. Then, screen processing is performed on the halftone image data using a screen with the high number of screen lines (e.g., the number of screen lines is 230), for example, to obtain halftone image data. The obtained halftone image data (toner pattern image data) is used to form the toner pattern image P1 of each toner color component on the intermediate transfer belt 11. Here, the forming condition (image forming condition) is changed each patch.

The toner pattern image data may be held in the image data generation unit 302 after the screen processing described above has been performed. In this case, in step S12, the toner pattern image P1 is formed using the held toner pattern image data. Alternatively, each time the toner pattern image P1 is formed, toner pattern image data may be generated by the image data generation unit 302. The position of the intermediate transfer belt 11 forming the toner pattern image P1 is a position that can be detected by the patch detection sensor 50 when the intermediate transfer belt 11 is driven. Also, the toner patterns of the toner color components are formed not overlapping one another. Here, as has already been explained, the reason why the maximum density is multiplied by 0.8 is because the detection accuracy is not high when the image print ratio is 100 percent when using the specular reflection patch detection sensor 50 in the present example. Also, the reason for performing screen processing with the high number of screen lines will be described below with reference to FIGS. 11, 12, 13, 15, 17, 18, and the like. Note that the high number of screen lines refers to a relatively high number of screen lines from among the plurality of numbers of screen lines of the screen processing. In the present example, halftone processing can be performed in two ways, with screen lines of 230 or 170, and screen processing with the relatively high number of screen lines of 230 is referred to as screen processing with the high number of screen lines.

The development contrast Vc of each patch included in the pattern of each color in the forming of the toner pattern image P1 and the charging bias voltage Vd, the developing bias voltage Vdc, and an exposure amount LPW for achieve this are set as follows. Here, the forming condition of each patch is represented by “Dmax”, the following character (Y, M, C, K) represents the color component, and the following number (1 to 5) represents the forming condition (also referred to as the image forming condition) index.
DmaxY1, DmaxM1, DmaxC1, DmaxK1 (first forming condition): Vc1, Vd1, Vdc1, LPW1
DmaxY2, DmaxM2, DmaxC2, DmaxK2 (second forming condition): Vc2, Vd1, Vdc1, LPW2
DmaxY3, DmaxM3, DmaxC3, DmaxK3 (third forming condition): Vc3, Vd2, Vdc2, LPW2
DmaxY4, DmaxM4, DmaxC4, DmaxK4 (fourth forming condition): Vc4, Vd3, Vdc3, LPW2
DmaxY5, DmaxM5, DmaxC5, DmaxK5 (fifth forming condition): Vc5, Vd3, Vdc3, LPW3

Here, the charging bias voltage Vd is a condition where Vd1 is −500 V, Vd2 is −600 V, and Vd3 is −700 V. The developing bias voltage Vdc is a condition taking into account a fog removal potential of 150 V where Vdc1 is −350 V, Vdc2 is −450 V, and Vdc3 is −550 V. The exposure amount LPW of the laser beam amount is a condition represented by the amount of light on the surface of the photosensitive drum where LPW1 is 0.16 μJ/cm2, LPW2 is 0.24 μJ/cm2, and LPW3 is 0.32 μJ/cm2.

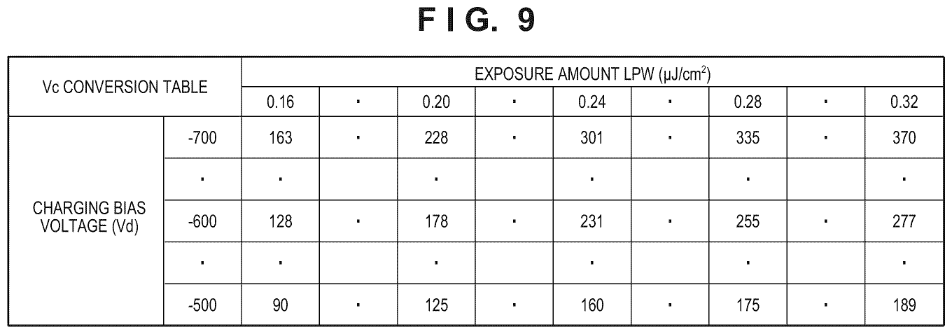

FIG. 9 illustrates an example of a table for obtaining the development contrast Vc from the charging bias voltage Vd and the exposure amount LPW. The development contrast table is generated in advance together with the characteristics of the photosensitive drum and stored in the image processing unit 84. In the present embodiment, Vc1 is 90 V, Vc2 is 160 V, Vc3 is 231 V, Vc4 is 301 V, and Vc5 is 370 V. This is the same for other color components.

In step S13, the CPU 301 calculates the density value of each toner pattern by table calculation using the output value detected from the toner pattern image P1 by the patch detection sensor 50.

In step S14, the CPU 301 determines a development contrast VcA for satisfying TargetA (image print ratio 80%), which is a target value for the density in the patch detection control.

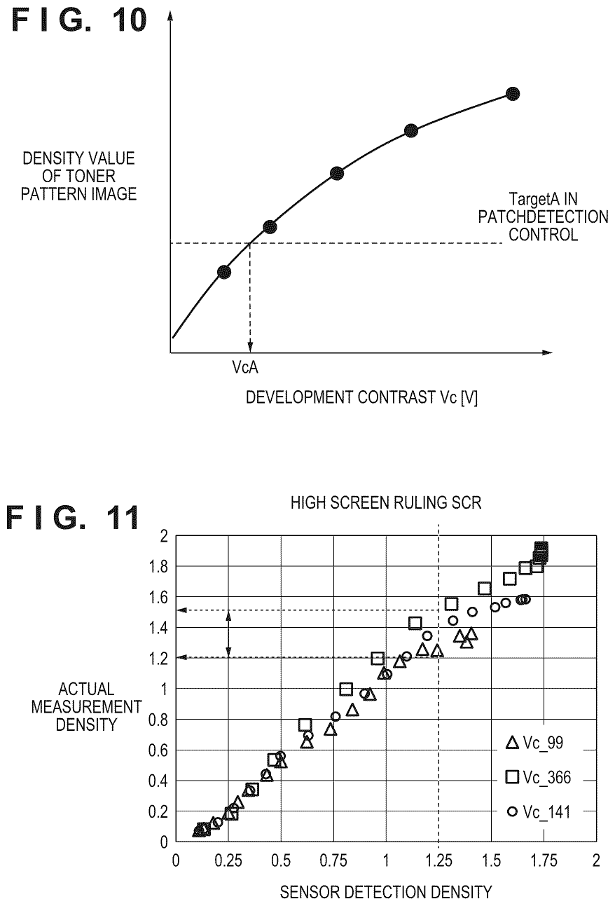

FIG. 10 illustrates the relationship between each patch density (vertical axis) of the toner pattern image P1 obtained in step S13 and the development contrast Vc (horizontal axis). In the present example, for one color component, patches are formed using five image conditions, and in FIG. 10, five points corresponding to the toner pattern images are indicated. The CPU 301 calculates the development contrast VcA for realizing TargetA in the patch detection control using the relationship illustrated in FIG. 10 via linear interpolation using 2 points either side of the target. In the present embodiment, the development contrast VcA corresponding to the target density is 131 V, for example.

In step S15, a forming condition A is calculated for realizing the development contrast VcA. The forming condition A is calculated via linear interpolation of the forming conditions of two points either side of the target. In this example, VcA=131 V is between Vc1=90 V and Vc2=160 V. In other words, the forming condition to be obtained is between the first forming condition and the second forming condition. Here, the forming condition 1 is determined by Vc1, Vd1, Vdc1, and LPW1, and the forming condition 2 is determined by Vc2, Vd1, Vdc1, and LPW2. The development contrast Vc is a dependent condition determined by another condition as illustrated in FIG. 9, and the reason why it is different for the forming condition 1 and the forming condition 2 is only because the exposure amount LPW is LPW1 for the forming condition 1 and LPW2 for the forming condition 2. Regarding this, in a case where the development contrast table of FIG. 9 is referenced and the charging bias voltage Vd is Vd1 (for example, −500 V), the exposure amount LPW is obtained via interpolation so that the development contrast is VcA (for example, 131 V). The target (goal) forming condition obtained in this manner corresponds to: charging bias voltage A=−500 V, developing bias A=−350 V, and exposure amount A=0.21 μJ/cm2. Note that the method for determining the forming condition is not limited to a calculation method in which either the charging bias or the exposure amount is fixed, a method of calculating from a table, or another similar method.

Note that in the example described above, with a certain development contrast and the development contrast directly above or below, the forming condition for determining these is provided by making one of either the charging bias voltage Vd or the exposure amount LPW, for example, different and keeping the other in common. For example, only the exposure amount LPW may be made different for the forming condition 1 and the forming condition 2, and only the charging bias voltage Vd is made different for the forming condition 2 and the forming condition 3. This is the same for the other forming conditions. Accordingly, the number of forming conditions to be determined via interpolation can be one, and the forming condition can be easily and accurately determined.

### Tone Correction Control via Patch Detection

Next, the tone correction control will be described. FIG. 21 is a schematic view of toner pattern images P2 and P3 as images for detection for tone correction used in tone correction control. The toner pattern image P2 is used for generating an LUT (γ correction table) used to convert image data when forming text and line images. Screen processing using a screen with the high number of screen lines is performed on the toner pattern image P2. The toner pattern image P3 is used for generating an LUT (γ correction table) used to convert image data when forming photo images. Screen processing using a screen with the low number of screen lines is performed on the toner pattern image P3.

The toner pattern image P2 includes six images of a plurality of tone levels, 10%, 30%, 45%, 60%, 80%, and 100%. The image data (image data for detection) of the toner pattern image P2 is prestored in the ROM. The CPU 301 reads out the image data for detection of the toner pattern image P2 from the ROM and inputs it to the image processing unit 84. The image processing unit 84 performs screen processing using a screen with the high number of screen lines on the image data for detection of the toner pattern image P2. In this manner, the toner pattern image P2 is formed on the intermediate transfer belt 11 by the image forming apparatus 100. The CPU 301 detects the toner pattern image P2 via the patch detection sensor 50, obtains six densities of the toner pattern image P2, and obtains the tone characteristics from the density detection results. The CPU 301 generates a LUT for making the tone characteristics the ideal tone characteristics as the LUT for the screen with the high number of screen lines.

As with the toner pattern image P2, the toner pattern image P3 includes six images of a plurality of tone levels, 10%, 30%, 45%, 60%, 80%, and 100%. The image data (image data for detection) of the toner pattern image P3 is prestored in the ROM. The CPU 301 reads out the image data for detection of the toner pattern image P3 from the ROM and inputs it to the image processing unit 84. The image processing unit 84 performs screen processing using a screen with the low number of screen lines on the image data for detection of the toner pattern image P3. In this manner, the toner pattern image P3 is formed on the intermediate transfer belt 11 by the image forming apparatus 100. The CPU 301 detects the toner pattern image P3 via the patch detection sensor 50, obtains six densities of the toner pattern image P3, and obtains the tone characteristics from the density detection results. The CPU 301 generates a LUT for making the tone characteristics the ideal tone characteristics as the LUT for the screen with the low number of screen lines.

Then, in the case of the image forming apparatus 100 forming a text image, the image processing unit 84 performs screen processing with the high number of screen lines on the image information 88 (input image data) and converts the post-screen-processing image data on the basis of the LUT corresponding to the screen with the high number of screen lines. The image data output from the image processing unit 84 is converted into a control signal for laser control at the image data generation unit 302 and transferred to the laser drive units 303a to 303d. In this manner, an image is formed by the image forming stations Pa, Pb, Pc, and Pd.

Also, in the case of the image forming apparatus 100 forming a photo image, the image processing unit 84 performs screen processing with the low number of screen lines on the image information 88 (input image data) and converts the post-screen-processing image data on the basis of the LUT corresponding to the screen with the low number of screen lines. The image data output from the image processing unit 84 is converted into a control signal for laser control at the image data generation unit 302 and transferred to the laser drive units 303a to 303d. In this manner, an image is formed by the image forming stations Pa, Pb, Pc, and Pd.

Note that in a case where the number of sheets an image has been printed on reaches a first page number from when the previous toner pattern image P2 was formed, the toner pattern image P2 is formed on the intermediate transfer belt 11 by the CPU 301. Also, in a case where the number of sheets an image has been printed on reaches a second page number from when the previous toner pattern image P3 was formed, the toner pattern image P3 is formed on the intermediate transfer belt 11 by the CPU 301. By forming the toner pattern images P2 and P3 in this manner, the LUT for making the tone characteristics of the image with difference attributes formed by the image forming apparatus 100 the ideal tone characteristics is successively updated.

### Patch Image Processing for Maximum Density Correction

Next, image processing of a patch for adjustment when performing maximum density correction control will be described. Note that the image processing described in the present embodiment is an example and is not limited to the example.

In the present embodiment described herein, halftone image processing of a screen processing method is performed on halftone image data of an output image. Via the screen processing, the halftone image data is converted to halftone image data constituted by binarized pixels.

As described above, the image information 88 (input image data) can be categorized into the following three types of images.
(1) Text and line image
(2) Photo image
(3) Graphic image

Here, for (1) text and line image, the reproducibility of the shape of text and lines is emphasized, and for (2) photo image and (3) graphic image, color reproducibility and tone reproducibility are emphasized. In the present embodiment, screen processing with the high number of screen lines, for example, 230 line/inch screen processing, is performed for text and line images, and screen processing with the low number of screen lines, for example, 170 line/inch screen processing, is performed for photo images and graphic images.

Typically, in the case of an image forming apparatus that can perform a plurality of types of screen processing, tone correction control is performed for each screen, and tone characteristics for each screen are improved using a correction table (LUT) for the generated input image. In this manner, appropriate processing can be performed for output images having different types of features.

However, in maximum density correction control, correction control is not performed for each screen. The maximum density of the output product is the density at an image print ratio of 100%, and halftone processing is not performed on portion with an image print ratio of 100%. This is because the optimal maximum density value and the forming condition for achieving this do not change depending on the difference in the halftone processing.

Here, to determine the image forming condition for forming an image of maximum density, typically, a detection image with an image print ratio of 100% is preferably formed. However, for example, in a case where a detection image is formed using black toner, when the high image print ratio is high, the detection accuracy of the optical sensor is reduced.

Regarding this, it is plausible to use a detection image with a slightly lowered print ratio (for example, an image print ratio of 80%). Thus, in a case where the print ratio of the detection image is less than 100%, a detection image reproduced using a screen with the low number of screen lines is formed. This is because a typical printed product emphasizes photo image reproducibility over text and line image reproducibility.

However, according to experiments by the present inventors, it was found that, in a case where a detection image reproduced using a screen with the low number of screen lines is detected using an optical sensor, variation in the detection signal values of the sensor increases. Thus, in a case where the image forming condition is controlled on the basis of the detection result of a detection image with the low number of screen lines, the density of the output image is problematically not stable.

With the image forming apparatus 100 according to the present embodiment, screen processing with the high number of screen lines of 230 lines/inch is performed on text and line images and screen processing with the low number of screen lines of 170 lines/inch is performed on photo images and graphic images. Also, with the image forming apparatus 100 according to the present embodiment, the number of screen lines of a detection image (also referred to as a patch image) used in maximum density correction control is 230 lines/inch. Here, a comparative example using a screen with the low number of screen lines of 170 lines/inch will be described.

FIG. 11 is a graph illustrating the relationship between density values detected by the patch detection sensor 50 of a patch for correction corresponding to 20 tones (horizontal axis) and density values of when the density of a patch for correction output on a sheet P is actually measured by a colorimeter or the like (vertical axis). A feature of the present embodiment is a detection image subjected to screen processing with the high number of screen lines of 230 lines/inch high being detected by the patch detection sensor 50 and a value obtained by converting the detect patch image signal value to a density value using a patch detection brightness and density conversion table being set on the horizontal axis as the detection density value. Also, the same patch image is transferred onto the sheet P, and after a subsequent fixing process, the density actual measurement value of the output image on the output sheet P is set on the vertical axis.

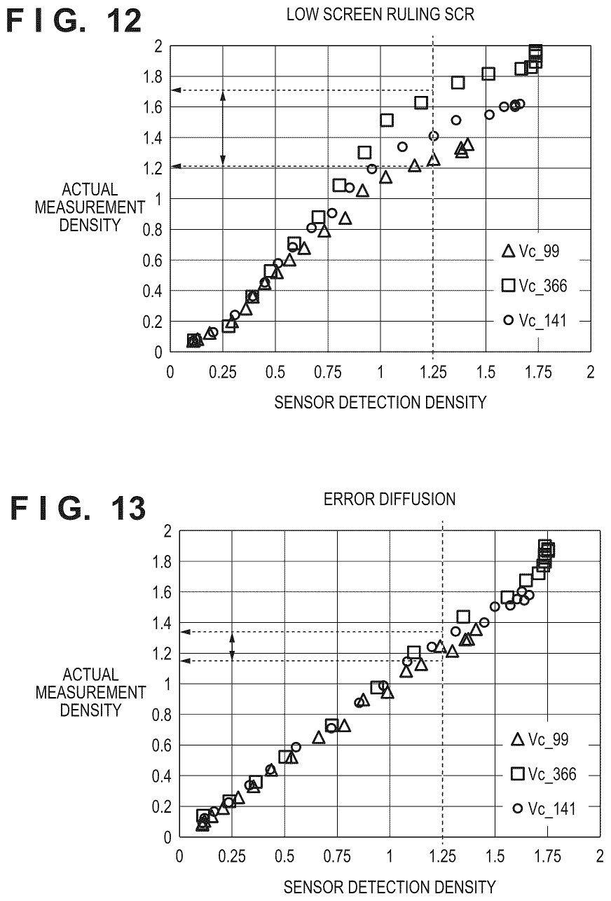

FIG. 12 is a graph illustrating the relationship between the patch sensor detection density values (horizontal axis) correspond to 20 tones and the patch actual measurement density values (vertical axis) in the case of using the low number of screen lines of 170 lines/inch as a comparative example. As in FIG. 11, in the graph of FIG. 12, the horizontal axis is the density value detected by the patch detection sensor 50 of the patch image formed on the intermediate transfer body, and the vertical axis is the density measurement value of the patch image formed on the sheet P.

In FIGS. 11 and 12, a relationship when a patch image is formed with Vc equaling 99 V corresponding to a case of low development contrast is indicated with a Δ symbol, and a relationship when a patch image is formed with Vc equaling 399 V correspond to a case of high development contrast is indicated with a □ symbol. Also, a relationship when a patch image is formed with Vc equaling 141 V corresponding to a case of a development contrast between the two described above is indicated with a ○ symbol.

In the maximum density correction control, a density value D corresponding to the target density is approximately 1.25 in a case where the image print ratio is approximately 80%. FIGS. 11 and 12 indicate how much the actual measurement density values change due to the forming condition in a case where D=1.25 is detected by the patch detection sensor 50.

By comparing FIG. 11 and FIG. 12, it can be seen that the patch for correction subjected to screen processing with the high number of screen lines as in the present embodiment has less change in the actual measurement density value due to a difference in the forming condition indicated by the development contrast. In the case of the low number of screen lines and the value detected by the patch detection sensor 50 being 1.25, the actual measurement density changes due to a difference in the forming condition with the density value D ranging from approximately 1.20 to 1.70. In contrast, in the case of the high number of screen lines and the detected value being 1.25, it can be seen that variation is reduced with the density value D ranging from approximately 1.20 to 1.50. Depending on the forming condition, the difference between the sensor detection density value and the actual measurement density value is increased, leading to control accuracy in density control being greatly decreased. This causes instability in terms of density, color, and tone characteristics.

The cause of such variation in density is a difference in the latent image state. In a case where a patch image is formed using an image with an image print ratio of 100%, no difference appears in the latent image state due to a difference in the halftone processing. However, when the image print ratio is 80% and the halftone processing is different, a difference appears in the latent image state.

A latent image state that tends to have increased density variation is a state in which the toner tends to stack in the vertical direction (thickness direction). With a specular reflection type patch detection sensor, the toner amount is detected as a density value using the ratio of how much the toner on the intermediate transfer belt coats the belt underlayer portion. If the toner amount increases to stack the toner in the vertical direction without the underlayer coating ratio changing, the density value to be detected cannot follow the change in the toner amount, increasing the error. In other words, it can be said that the density detected by the patch detection sensor 50, with respect to a change in the density due to a change in the toner amount in the thickness direction, has large variation caused by different image forming conditions.

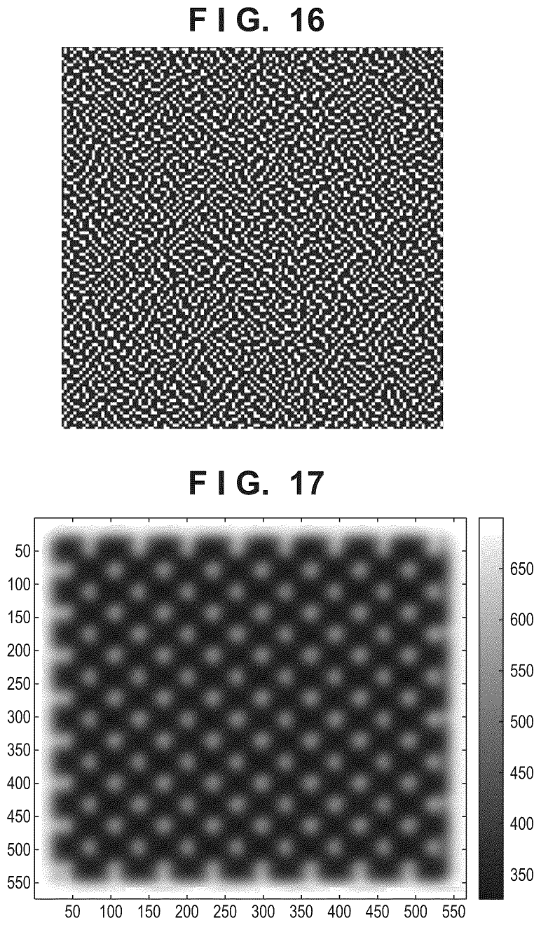

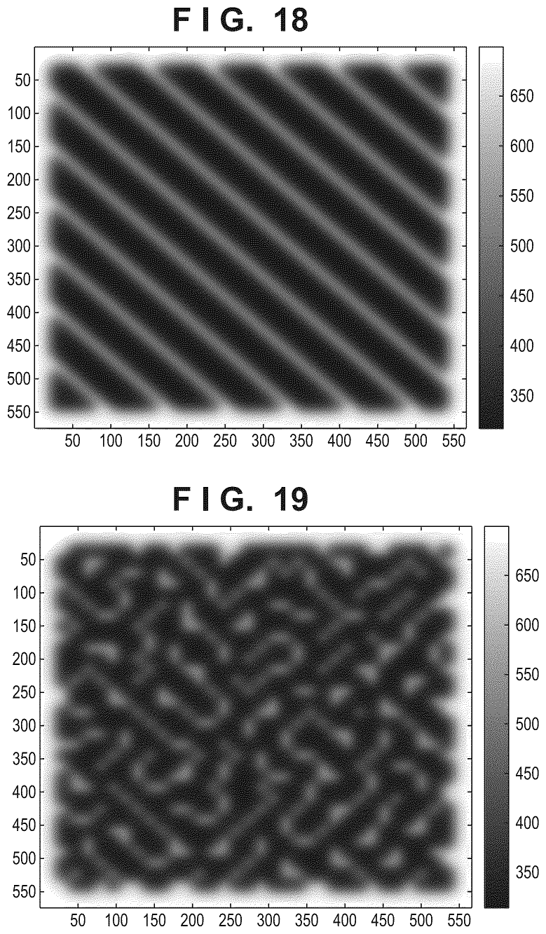

Here, FIGS. 14 and 15 are enlarged views of a central portion of the halftone image data obtained by performing screen processing on a digital image with pixels of a density with a maximum density of 80% uniformly distributed so that the image print ratio is a value less than 100%, for example, 80%. Density with a maximum density of 80% is an example, and it is sufficient that the density is less than the maximum density and the detection accuracy for a black toner image is maintained. FIG. 14 is an example of a digital image obtained by performing screen processing at 230 lines/inch, which is a feature of the present embodiment. As a comparative example, FIG. 15 is a digital image obtained by performing screen processing at 170 lines/inch for the same image. Here, a latent image state simulation is performed on the digital image of FIGS. 14 and 15 using the forming conditions of charging bias voltage Vd_B=−700 V, developing bias voltage Vdc_B=−550 V, and exposure amount LPW_B=0.22 μJ/cm2 and a potential distribution is calculated. FIG. 17 is the simulation result of the potential distribution of an image carrier surface when a simulation is performed to form a latent image for the digital image of FIG. 14, and FIG. 18 is the same for the digital image of FIG. 15.

Also, the variation (standard deviation) in the potential distribution in FIGS. 17 and 18 is the result 46.8 V in the case of the screen processing with the high number of screen lines of FIGS. 17 and 58.7 V in the case of the screen processing with the low number of screen lines of FIG. 18. When the standard deviation increases, the potential fluctuation of the latent image increases and the toner tends to stack in the vertical direction. Thus, variation in the density detected by the patch detection sensor 50 is increased.

As described above, by the image forming apparatus that performs a plurality of types of halftone processing are performed on the input image and forms an output product, a patch image processed by screen processing with a higher number of screen lines is used as the patch image for correction in the maximum density correction control. In this manner, the accuracy of the sensor detection density can be improved, and maximum density correction control can be performed at a high accuracy.

### Modified Example

In the embodiment, the same toner pattern image, that is, a patch image, is used for all of the color components. However, since the one that has a reduced detection accuracy at an image print ratio of 100% is Bk, that is, a black image, only the black component toner pattern image may be set to a print ratio of 80%. In this case, the toner pattern images of other color components may have a print ratio of 100%. Thus, in this case, the number of screen lines for colors other than black may be the high number of screen lines or the low number of screen lines. This also applies to the second embodiment.

Note that in the present embodiment, as illustrated in FIG. 6, the toner pattern image P1 with patches of different forming conditions continuously arranged is formed on the intermediate transfer body. However, it is sufficient that the density of the patches of different forming conditions can be detected by the patch detection sensor 50, and thus the patches of different forming conditions do not need to be continuously arranged. For example, a patch of each color component is formed using the forming condition 1, the density of each patch is detected by the patch detection sensor 50, and each density value is stored. Then, a patch of each color component is formed changing the forming condition to the forming condition 2, the density of each patch is detected by the patch detection sensor 50, and each density value is stored. This is repeated in a similar manner for the forming conditions 3, 4, and 5, and the density of each formed patch is stored to obtain data indicating the correlation between the development contrast and the density values of the toner pattern images as illustrated in FIG. 10. A forming condition for realizing the target maximum density may be determined on the basis of this. In this manner, since the boundary between patches does not include a region of changing forming conditions, the density detection accuracy can be improved. This also applies to the second embodiment.

### Second Embodiment

In the first embodiment described above, in the halftone processing of a patch image for correction in the maximum density correction control, a patch for correction subjected to screen processing with the high number of screen lines is used over a patch for correction subjected to screen processing with the low number of screen lines. In this manner, the relationship between the detection density values of the patch for correction and the actual measurement density values is stabilized. Thus, the detection density accuracy can be improved, and density correction control can be performed with high accuracy. In the present embodiment, a method for performing density correction control with even higher accuracy will be described. Note that the image forming apparatus, the image control unit, and the maximum density correction control flow according to the present embodiment are as in the first embodiment (FIG. 8 and the like) and thus will not be described.

In the present embodiment, the screen processing with the high number of screen lines of 230 lines/inch is performed on text images; error diffusion processing is performed on line images used in CAD, maps, and the like; and the screen processing with the low number of screen lines of 170 lines/inch is performed on photo images and graphic images to perform tone forming processing. Then, in the present embodiment, error diffusion halftone processing is performed on a patch image for correction when performing maximum density correction control. This will be described below.

FIG. 13 is a graph illustrating the relationship between density values detected by the patch detection sensor 50 of a patch for correction corresponding to 20 tones subjected to error diffusion processing (horizontal axis) and density values of when the density of a patch for correction output on a sheet P is actually measured (vertical axis).

In the maximum density correction control, the density value D corresponding to the target density is approximately 1.25 in a case where the image print ratio is approximately 80%. As described above, in the first embodiment, when the screen processing with the low number of screen lines is performed, due to a difference in the forming condition, the actual measurement density D changes in a range of approximately 1.20 to 1.70 with respect to a patch sensor detection value of 1.25. Also, when the screen processing with the high number of screen lines is performed, variation is reduced with D ranging from approximately 1.20 to 1.50. Regarding this, when error diffusion processing, a feature of the present embodiment, is performed, as seen in FIG. 13, variation is reduced with D ranging from approximately 1.15 to 1.35.

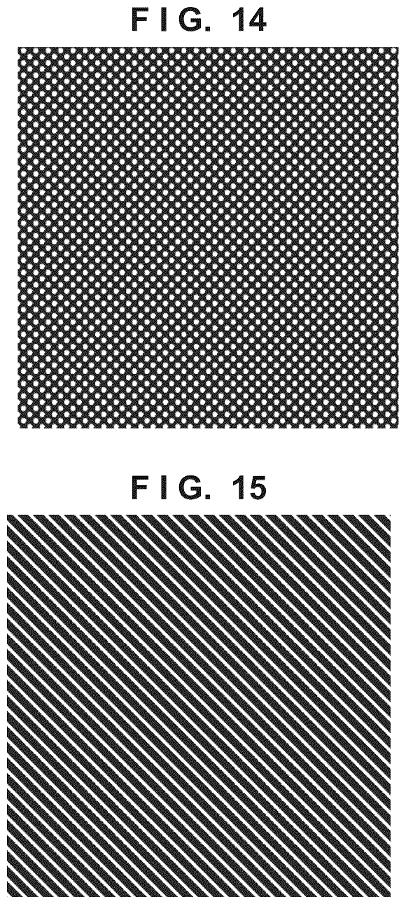

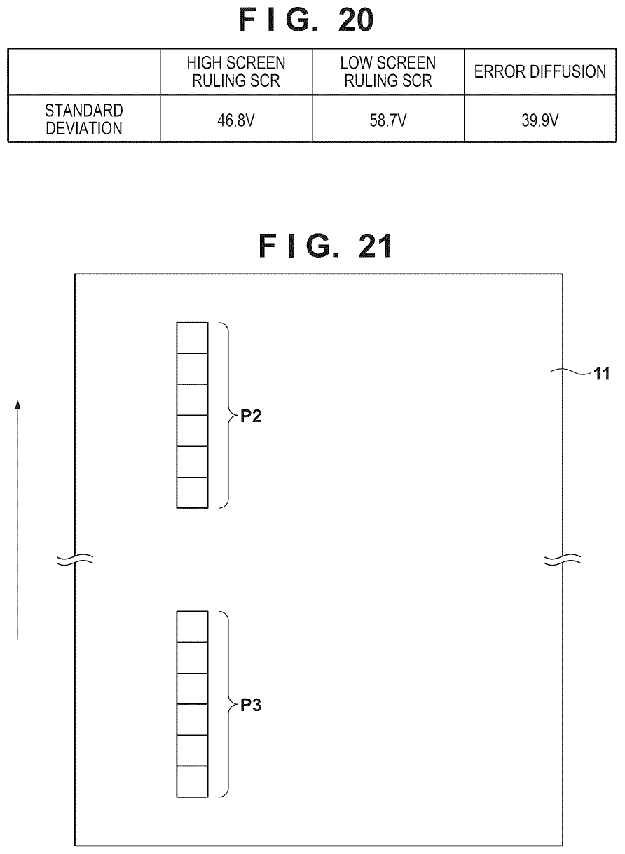

As in the first embodiment, a latent image state simulation is performed on a digital image subjected to error diffusion processing such as that illustrated in FIG. 16, and the result of calculating the potential distribution on the image carrier is illustrated in FIG. 19. The original digital image may be an image with pixels of a low density with respect to the maximum density, for example, a density of 80%, uniformly distributed. Calculating the variation (standard deviation) of the potential in the potential distribution simulation result as in FIG. 19 results in 39.9 V. From these values, by comparing with cases of performing the screen processing with the low number of screen lines and the screen processing with the high number of screen lines as halftone processing, it can be seen that potential variation is reduced the most when error diffusion processing is performed (FIG. 20). This means that the curve of the latent image state, which is a cause of density variation, can be keep low when error diffusion processing is performed as halftone processing.

As described above, a plurality of types of halftone processing are performed on the input image. With the image forming apparatus forming an output product, in the present embodiment, error diffusion processing is performed as halftone processing on a patch image for correction in maximum density correction control. In this manner, the accuracy of the sensor detection density can be improved, and maximum density correction control can be performed at a high accuracy.

Also, it is sufficient that the number of screen lines of the detection image used in maximum density correction control of the embodiment described above is greater than 190 lines/inch. For example, the number of screen lines of the detection image used in maximum density correction control may be 230 lines/inch. In this case, the number of screen lines of the detection image used in the maximum density correction control is greater than the number of screen lines used for text images and line images.

### Other Embodiments

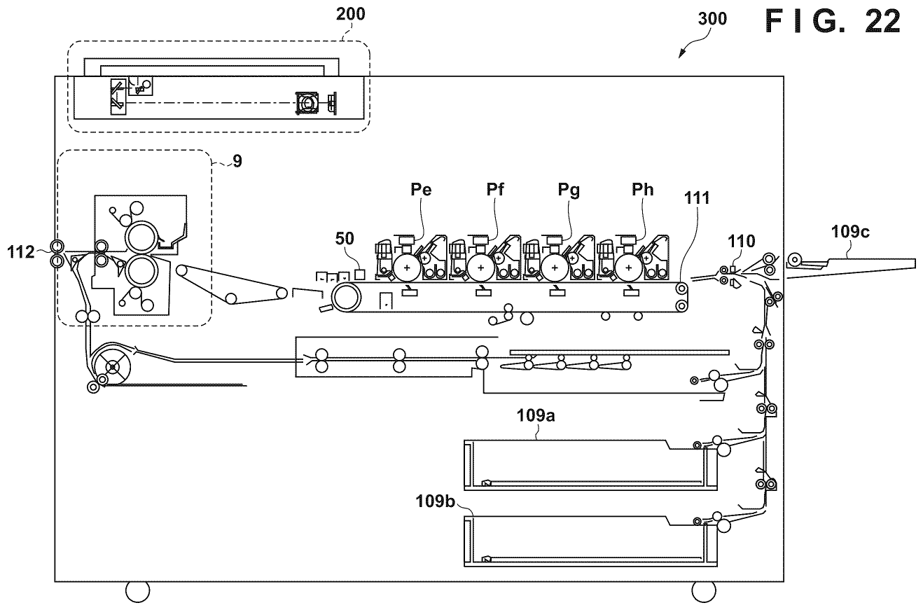

The laser scanner 31 in the first embodiment and the second embodiment has a configuration in which a laser from the light source 32 scans the photosensitive drum 1a via a rotating polygon mirror 33. However, the image forming apparatus 100 is not limited to this configuration. Instead of the image forming apparatus 100, the configuration of an image forming apparatus 300 illustrated in FIG. 22 may be used in the present disclosure.

FIG. 22 is a schematic cross-sectional view of the image forming apparatus 300. Note that hereinafter, units similar to that in the image forming apparatus 100 illustrated in FIG. 1 are given the same reference number and descriptions thereof are omitted. In the image forming apparatus 300, four image forming stations Pe, Pf, Pg, and Ph are provided side by side in the sheet conveyance direction as image forming units. The image forming stations Pe, Pf, Pg, and Ph each form a toner image of different colors. For example, the image forming station Pe forms a yellow toner image, the image forming station Pf forms a magenta toner image, the image forming station Pg forms a cyan toner image, and the image forming station Ph forms a black toner image.

Sheets are supported in cassettes 109a and 109b and a manual feed tray 109c. Of the cassettes 109a and 109b and the manual feed tray 109c, a sheet is feed from a pre-instructed supply source and conveyed to a registration roller 110. The registration roller 110 conveys the sheet to a transfer belt 111 so that toner image formed by the image forming stations Pe, Pf, Pg, and Ph are layered on the sheet and transferred.

The sheet conveyed to the transfer belt 111 is carried by the transfer belt 111 and transferred to overlap the toner image formed at each image forming station Pe, Pf, Pg, and Ph. In this manner, a full color toner image is formed on the sheet. The transferred toner image is fused and fixed to the sheet at the fixing device 9 with heat and pressure, and the sheet is discharged from the image forming apparatus 300 at a discharge roller 112.

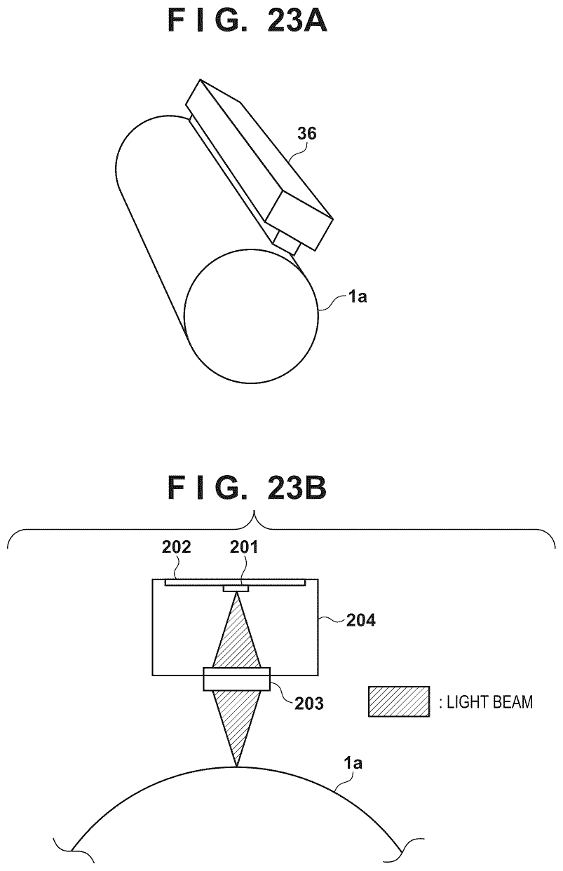

Next, an exposure head 36 included in each image forming stations Pe, Pf, Pg, and Ph will be described with reference to FIGS. 23A and 23B. Note that the exposure heads 36 in the image forming stations Pe, Pf, Pg, and Ph share a similar configuration. Hereinafter, the exposure head 36 (also referred to below as exposure head 36a) included in the image forming station Pe will be described.

The exposure head 36a includes a light-emitting element group 201, a printed substrate 202 on which the light-emitting element group 201 is mounted, a rod lens array 203, and a housing 204 where the rod lens array 203 and the printed substrate 202 are attached. Note that at the factory, for the exposure head 36a, focus adjustment for adjusting the spot diameter at a light gathering position of the light-emitting element group 201 to a predetermined size and light amount adjustment of the light-emitting element group 201 is performed. The light-emitting group 201 is arranged in a second direction intersecting the rotation direction (first direction) of the photosensitive member 1a. Alternatively, the light-emitting group 201 is arranged along the surface of the photosensitive member 1a in the direction of the rotary shaft of the photosensitive member 1a.

In the exposure head 36a, the light-emitting element group 201 emits light on the basis of a signal sent from the image data generation unit 302. The light emitted from the light-emitting element group 201 is gathered at the photosensitive drum 1a via the rod lens array 203, and the photosensitive drum 1a is exposed to the light. In this manner, an electrostatic latent image corresponding to the image data is formed on the photosensitive drum 1a.

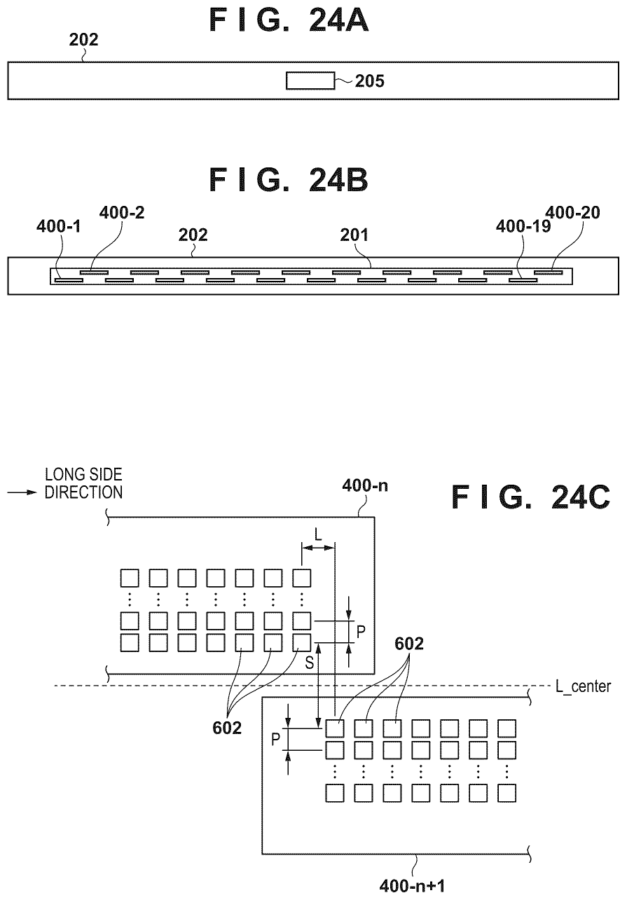

FIG. 24A is a schematic view illustrating the surface opposite the surface where the light-emitting element group 201 is mounted (hereinafter referred to as the non-light-emitting-element-mounted surface). FIG. 24B is a schematic view illustrating the surface where the light-emitting element group 201 is mounted (hereinafter referred to as the light-emitting-element-mounted surface). The light-emitting element group 201 includes 20 light-emitting element array chips 400-1 to 400-20 arranged in a staggered pattern. In each light-emitting element array chip 400-1 to 400-20, light-emitting elements 602 are arranged in the long side direction and the short side direction of the chip at a predetermined pitch.

In one chip, 748 light-emitting elements 602 are arranged in the chip long side direction at a pitch (approximately 21.16 μm) with a resolution of 1200 dpi, and a plurality of columns of the light-emitting elements 602 are arranged in the chip short side direction. In other words, the end-to-end distance of the 748 light-emitting points in the long side direction in one chip is approximately 15.8 mm. Twenty of the light-emitting element groups 201 are arranged in the long side direction of the chip, making the number of light-emitting elements that can expose light 14960 elements, and image formation corresponding to an image width of approximately 316 mm is possible. The light-emitting element array chips 400-1 to 400-20 are arranged in a staggered manner as illustrated in FIG. 24B.

FIG. 24C illustrates the state of an inter-chip boundary portion between the light-emitting element array chip 400-n and light-emitting element array chip 400-n+1. Here, n is a natural number from 1 to 19. At the inter-chip boundary portion, the pitch in the long side direction of the light-emitting elements is a pitch (approximately 21.16 μm) with a resolution of 1200 dpi. The gap (S in the diagram) between light-emitting points of the adjacent chips is approximately 127 μm (corresponding to 6 pixels at 1200 dpi and 4 pixels at 800 dpi). Also, the gap (L in the diagram) between light-emitting points in the long side direction of the exposure head 36a is approximately 21.16 μm (corresponding to 1 pixel at 1200 dpi). Note that in the present disclosure, the gaps S and L between the light-emitting element array chips are not necessarily limited to the values described above.

On the non-light-emitting-element-mounted surface, a control signal line for control signals that control the light-emitting element array chips 400-1 to 400-20 from the image data generation unit 302 and a connector 205 that connects to a power source line for power supply are provided, and each light-emitting element array chip 400-1 to 400-20 is driven via the connector 205.

Also in a case where the present disclosure is applied to the image forming apparatus 300 according to the present embodiment, an image forming condition for forming an image with a target maximum density can be generated with high accuracy.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-197594, filed Nov. 21, 2023, Japanese Patent Application No. 2024-157739, filed Sep. 11, 2024 which are is hereby incorporated by reference herein in their entirety.

What is claimed is:

1. An image forming apparatus that forms an image on a sheet, comprising:
an image processor configured to perform halftone processing corresponding to an attribute of an image to be formed based on image data, the image processor outputting halftoned image data;
an image forming unit configured to be controlled on a basis of an image forming condition and form an image on a basis of the halftoned image data outputted by the image processor;
an image carrier on which a detection image is formed by the image forming unit;
a sensor configured to receive reflected light from the detection image; and
a processor configured to:
control the image forming unit to form a detection image for tone correction, the detection image for tone correction being subjected to halftone processing,
control a tone characteristic of an image of a first attribute to be formed by the image forming unit on a basis of a light-receiving result of light reflected from a first detection image by the sensor, the first detection image being subjected to halftone processing corresponding to the first attribute,
control a tone characteristic of an image of a second attribute different from the first attribute to be formed by the image forming unit on a basis of a light-receiving result of light reflected from a second detection image by the sensor, the second detection image being subjected to halftone processing corresponding to the second attribute,
control the image forming unit to form a detection image for target maximum density correction, the detection image for target maximum density correction being subjected to error diffusion processing as the halftone processing regardless of an attribute of the image to be formed, and
generate the image forming condition for correcting a target maximum density of the image to be formed by the image forming unit on a basis of a light-receiving result of light reflected from the detection image for the target maximum density correction by the sensor.

2. The image forming apparatus according to claim 1, wherein
the first attribute is a photo image, and
the second attribute is a text image.

3. The image forming apparatus according to claim 1, wherein
a number of screen lines used in halftone processing corresponding to the first attribute is 190 lines/inch or less, and
a number of screen lines used in halftone processing corresponding to the second attribute is greater than 190 lines/inch.

4. The image forming apparatus according to claim 1, wherein
the detection image for the target maximum density correction is an image formed so that density is thinner than the target maximum density.

5. The image forming apparatus according to claim 1, wherein
the image forming unit includes a rotating photosensitive member, a charging member configured to charge the photosensitive member, a light source configured to expose to light the photosensitive member charged by the charging member to form an electrostatic latent image on the photosensitive member, and a developing roller configured to develop the electrostatic latent image on the photosensitive member using toner, and
the light source includes a plurality of light-emitting elements arranged in a second direction intersecting a first direction in which the photosensitive member rotates.

6. The image forming apparatus according to claim 1, wherein
the image forming unit includes a photosensitive member, a charging member configured to charge the photosensitive member on a basis of a charging bias voltage, a light source configured to expose to light the photosensitive member charged by the charging member to form an electrostatic latent image on the photosensitive member, and a developing roller configured to develop the electrostatic latent image on the photosensitive member using toner, and
the image forming condition for correcting the target maximum density is the charging bias voltage.

7. The image forming apparatus according to claim 1, wherein
the image forming unit includes a photosensitive member, a charging member configured to charge the photosensitive member, a light source configured to expose to light the photosensitive member charged by the charging member to form an electrostatic latent image on the photosensitive member, and a developing roller configured to develop the electrostatic latent image on the photosensitive member using toner on a basis of a developing bias voltage, and
the image forming condition for correcting the target maximum density is the developing bias voltage.

8. The image forming apparatus according to claim 1, wherein
the image forming unit includes a photosensitive member, a charging member configured to charge the photosensitive member, a light source configured to expose to light the photosensitive member charged by the charging member to form an electrostatic latent image on the photosensitive member, and a developing roller configured to develop the electrostatic latent image on the photosensitive member using toner, and
the image forming condition for correcting the target maximum density is an exposure amount of the light source.

9. The image forming apparatus according to claim 1, wherein
the image processor converts image data on a basis of a tone correction condition corresponding to the attribute, and
the image forming condition for controlling the tone characteristic is the tone correction condition.

10. An image forming apparatus that forms an image on a sheet, comprising:
an image processor configured to perform halftone processing corresponding to an attribute of an image to be formed based on image data, the image processor outputting halftoned image data;
an image forming unit configured to be controlled on a basis of an image forming condition and form an image on a basis of the halftoned image data outputted by the image processor;
an image carrier on which a detection image is formed by the image forming unit;
a sensor configured to receive reflected light from the detection image; and
a processor configured to:
control the image forming unit to form a detection image for tone correction, the detection image for tone correction being subjected to halftone processing,
control a tone characteristic of an image of a first attribute to be formed by the image forming unit on a basis of a light-receiving result of light reflected from a first detection image by the sensor, the first detection image being subjected to halftone processing corresponding to the first attribute,
control a tone characteristic of an image of a second attribute different from the first attribute to be formed by the image forming unit on a basis of a light-receiving result of light reflected from a second detection image the sensor, the second detection image being subjected to halftone processing corresponding to the first attribute,
control the image forming unit to form a detection image for target maximum density correction, and
generate the image forming condition for correcting a target maximum density of the image to be formed by the image forming unit on a basis of a light-receiving result of light reflected from the detection image for the target maximum density correction by the sensor,
wherein the detection image for the target maximum density correction is an image subjected to halftone processing using a number of second screen lines greater than a number of first screen lines used in halftone processing corresponding to the first attribute.

11. The image forming apparatus according to claim 10, wherein
the halftone processing using the number of the second screen lines is halftone processing corresponding to the second attribute.

12. The image forming apparatus according to claim 10, wherein
the first attribute is a photo image, and
the second attribute is a text image.

13. The image forming apparatus according to claim 10, wherein
the number of the first screen lines is 190 lines/inch or less, and the number of the second screen lines is greater than 190 lines/inch.

14. The image forming apparatus according to claim 10, wherein
the detection image for the target maximum density correction is an image formed with a smaller density than the target maximum density.

15. The image forming apparatus according to claim 10, wherein
the image forming unit includes a rotating photosensitive member, a charging member configured to charge the photosensitive member, a light source configured to expose to light the photosensitive member charged by the charging member to form an electrostatic latent image on the photosensitive member, and a developing roller configured to develop the electrostatic latent image on the photosensitive member using toner, and
the light source includes a plurality of light-emitting elements arranged in a second direction intersecting a first direction in which the photosensitive member rotates.

16. The image forming apparatus according to claim 10, wherein
the image forming unit includes a photosensitive member, a charging member configured to charge the photosensitive member on a basis of a charging bias voltage, a light source configured to expose to light the photosensitive member charged by the charging member to form an electrostatic latent image on the photosensitive member, and a developing roller configured to develop the electrostatic latent image on the photosensitive member using toner, and
the image forming condition for correcting the target maximum density is the charging bias voltage.

17. The image forming apparatus according to claim 10, wherein
the image forming unit includes a photosensitive member, a charging member configured to charge the photosensitive member, a light source configured to expose to light the photosensitive member charged by the charging member to form an electrostatic latent image on the photosensitive member, and a developing roller configured to develop the electrostatic latent image on the photosensitive member using toner on a basis of a developing bias voltage, and
the image forming condition for correcting the target maximum density is the developing bias voltage.

18. The image forming apparatus according to claim 10, wherein
the image forming unit includes a photosensitive member, a charging member configured to charge the photosensitive member, a light source configured to expose to light the photosensitive member charged by the charging member to form an electrostatic latent image on the photosensitive member, and a developing roller configured to develop the electrostatic latent image on the photosensitive member using toner, and
the image forming condition for correcting the target maximum density is an exposure amount of the light source.

19. The image forming apparatus according to claim 10, wherein
the image processor converts image data on a basis of a tone correction condition corresponding to the attribute, and
the image forming condition for controlling the tone characteristic is the tone correction condition.
